(19) United States
(12) Patent Application Publication
(10) Pub. No.: US 2026/0217455 A1
(43) Pub. Date: Jul. 30, 2026

(54) PRODUCT MOVING DEVICE, METHOD FOR CONTROLLING SAME, AND COMPUTER PROGRAM

(71) Applicant: TELEXISTENCE INC., Tokyo (JP)

(72) Inventors: Nicolas CHOW CHIN SUNG, Tokyo (JP); Pablo Matias FERREIRO, Tokyo (JP)

(73) Assignee: TELEXISTENCE INC., Tokyo (JP)

(21) Appl. No.: 19/123,815

(22) PCT Filed: Nov. 9, 2023
(86) PCT No.: PCT/JP2023/040333

§ 371 Date: Mar. 31, 2026

(30) Foreign Application Priority Data
Nov. 11, 2022 (JP) 2022-181310

(51) Int. Cl. B65G 1/04; B25J 5/02; B25J 13/08

(52) U.S. Cl. CPC B65G 1/0435; B25J 5/02; B25J 13/088

(57) ABSTRACT

A product transfer apparatus is provided. The product transfer apparatus includes an arm unit having a holder unit configured to hold the product, a movement mechanism configured to move in an area between a stock shelf and a product display shelf, an acquisition unit configured to obtain a position of the arm unit, and a control unit configured to control the arm unit, the holder unit, the movement mechanism, and the acquisition unit. The control unit is configured to perform acquiring a position of the arm unit relative to a reference position of the product transfer apparatus, determining whether or not the arm unit is positioned within a predetermined area, and placing the product transfer apparatus in a state of starting operation of moving the product if the arm unit is positioned within the predetermined area.

### TECHNICAL FIELD

The present invention relates to a product transfer apparatus and a method of controlling the product transfer apparatus.

### BACKGROUND

JP2018-110755 discloses a product replenishment system which performs unmanned replenishment of products to reduce work labor. This product replenishment system includes an image capture device for capturing an image of a product as a target of replenishment, and a multi-joint robot apparatus for moving the product. The multi-joint robot apparatus picks up a product as the target of replenishment from a predetermined position where the product is placed beforehand, and moves the product to a product display shelf.

### SUMMARY

In the system described in JP2018-110755, in general, before starting operation of the stopped system by restarting, it is required to more correctly recognize the position and the posture of the robot apparatus. This is because, if the operation of the robot apparatus is started without recognizing the position and posture of the robot apparatus at the time of restarting, depending on the position and the posture of the robot apparatus at the time point, contact or collision of the hand and/or the arm of the robot apparatus with the surrounding equipment, etc. may occur inadvertently, and the hand and arm, or the surrounding equipment, etc. of the robot apparatus may be damaged. Recognition of the position and the posture of the robot apparatus may include calibration of differences between the position and the posture of the robot apparatus recognized by the system and the actual position and posture of the robot apparatus.

Such calibration may involve operation of driving parts including a hand and an arm of a robot apparatus. For example, in the state where the hand of the robot apparatus before starting calibration contacts the product display shelf, the hand of the robot apparatus or the product display shelf may be damaged by operation of driving parts of the robot apparatus at the time of performing calibration.

An object of the present disclosure is to provide a product transfer apparatus which makes it possible to prevent damages of the product transfer apparatus and equipment, etc. around the product transfer apparatus at the time of starting operation of the product transfer apparatus by restarting.

According to an aspect of the present disclosure, a product transfer apparatus configured to move a product placed on a stock shelf to a product display shelf which is different from the stock shelf is provided. The product transfer apparatus includes an arm unit having a holder unit configured to hold the product, a movement mechanism configured to move in an area between the stock shelf and the product display shelf, an acquisition unit configured to obtain a position of the arm unit, and a control unit configured to control the arm unit, the holder unit, the movement mechanism, and the acquisition unit. The control unit is configured to perform acquiring a position of the arm unit relative to a reference position of the product transfer apparatus by the acquisition unit when operation of the product transfer apparatus is started from an operation stop state, determining whether or not the arm unit is positioned within a predetermined area between the stock shelf and the product display shelf, and moving the arm unit into the predetermined area if the arm unit is not positioned within the predetermined area.

Other features and advantages of the present disclosure can be understood from the following description and the accompanying drawings which are given in an illustrative and non-comprehensive manner.

The present disclosure provides a product transfer apparatus, etc. which makes it possible to prevent damages of the product transfer apparatus and equipment, etc. surrounding the product transfer device at the time of starting operation of the product transfer apparatus by restarting.

### BRIEF DESCRIPTION OF THE DRAWINGS

FIG. 1 is a plan view schematically showing the layout of shelves in a store and a product transfer apparatus provided in the store;

FIG. 2(a) is a view showing a product display shelf viewed from the front side, and FIG. 2(b) is a view showing the product display shelf viewed from the back side;

FIG. 3 is a side view schematically showing structure of the product transfer apparatus;

FIG. 4 is a perspective view showing structure around a front end of an arm unit of the product transfer apparatus;

FIG. 5 is a block diagram showing structure of the product transfer apparatus;

FIG. 6 is an image of a product display shelf captured by a first camera (left side) of the product transfer apparatus;

FIG. 7 is a flow chart showing replenishment operation of a product by the product transfer apparatus;

FIG. 8 is a flow chart illustrating an operation example of the product transfer apparatus;

FIG. 9 is a view conceptually showing a positional relationship in a rotation direction about a pillar, between an upper portion and a lower portion of a first elevation mechanism; and

FIG. 10 is a view showing operation of retracting an arm unit into an area between two rails.

### DETAILED DESCRIPTION

Hereinafter, an embodiment of the present disclosure will be described with reference to the drawings.

### Layout Structure of Store

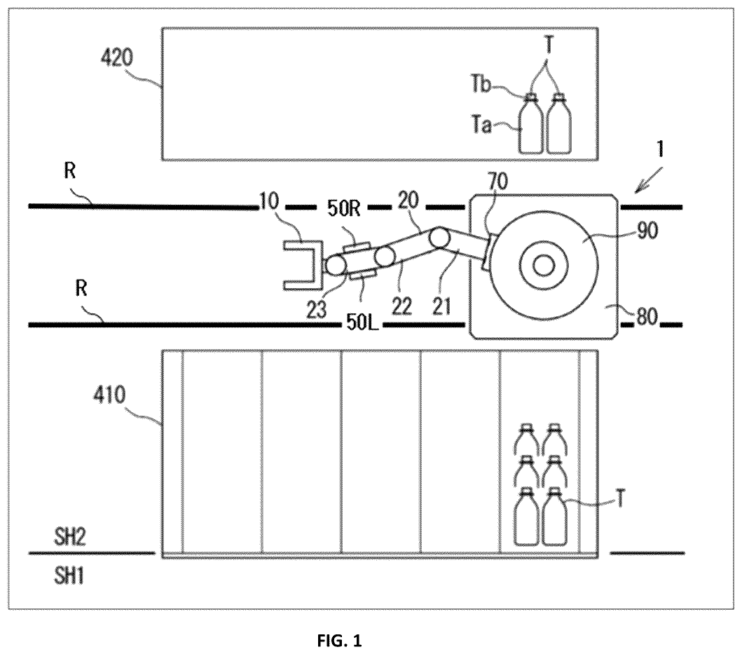

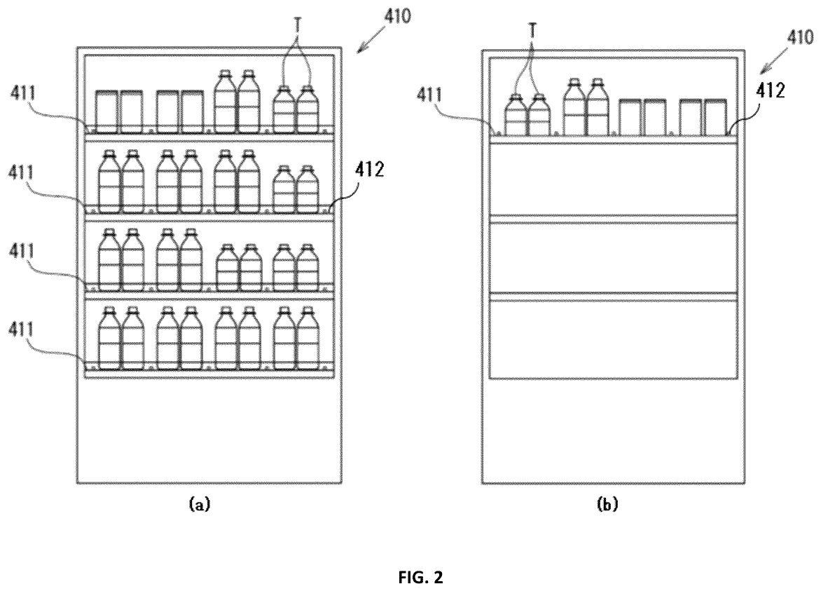

Firstly, layout structure of a store will be described. FIG. 1 is a plan view schematically showing the layout of shelves in a store and a product transfer apparatus provided in the store. FIG. 2(a) is a view showing a product display shelf viewed from the front side, and FIG. 2(b) is a view showing the product display shelf viewed from the back side.

As shown in FIG. 1, the inside of the store is divided into an in-store space SH1 and a backyard space SH2. The in-store space SH1 is a space where customers select and purchase products T. The backyard space SH2 is a space where the stock of the products T is stored. A product display shelf 410, a stock shelf 420, and a product transfer apparatus 1 are provided in the store. A track comprising two rails R is laid on a floor between the product display shelf 410 and the stock shelf 420 in the store, and the product transfer apparatus 1 is configured to move on these rails R in the left-right direction as shown in the drawing.

As shown in FIG. 2(a) and 2(b), the product display shelf 410 has a plurality of shelf plates 411 (also referred to as the levels of the product display shelves). A plurality of types of products T are placed on the shelf plate 411. For example, the products T of the same type are arranged in two rows or three rows. The products T may be arranged in only one row. A plurality of partition plates 412 dividing the products T arranged in each row are provided on the upper surface of each of the shelf plates. In FIG. 2, an example of products T of the same type arranged in two rows is illustrated, and in this example, a partition plate 412 is provided for every two rows of products T. The layout of the partition plate 412 is not limited to the above example, and the partition plate 412 can be arranged at intervals of one row or two or more rows.

The front side of the product display shelf 410 faces the in-store space SH1. So, customers can take products T from the front side of the product display shelf 410. The shelf plate 411 is inclined such that the front side gets lower relative to the back side. In the structure, when a customer takes a product T, other products T arranged behind the product T slide on the shelf plate 411, and move toward the front side.

The back side of the product display shelf 410 faces the backyard space SH2. So, a store employee or the product transfer apparatus 1 replenishes the product display shelf 410 with the products T from the back side of the product display shelf 410. Although not shown in the drawings, doors may be provided on the front and back sides of the product display shelf 410. In FIG. 1, though only one product display shelf 410 is drawn for simplicity of illustration, a plurality of product display shelves 410 may be provided in the store.

The stock shelf 420 is provided to face the product display shelf 410, and the front surface of the stock shelf 420 and the back surface of the product display shelf 410 face each other. As in the case of the product display shelf 410, the stock shelf 420 includes a plurality of shelf plates (levels) disposed in the height direction. Replenish target products as target products of replenishment for the product display shelf 410 are arranged on the shelf plate of the stock shelf 420. The replenishment target products may be arranged by a store employee, or the product transfer apparatus 1.

### Structure of the Product Transfer Apparatus 1

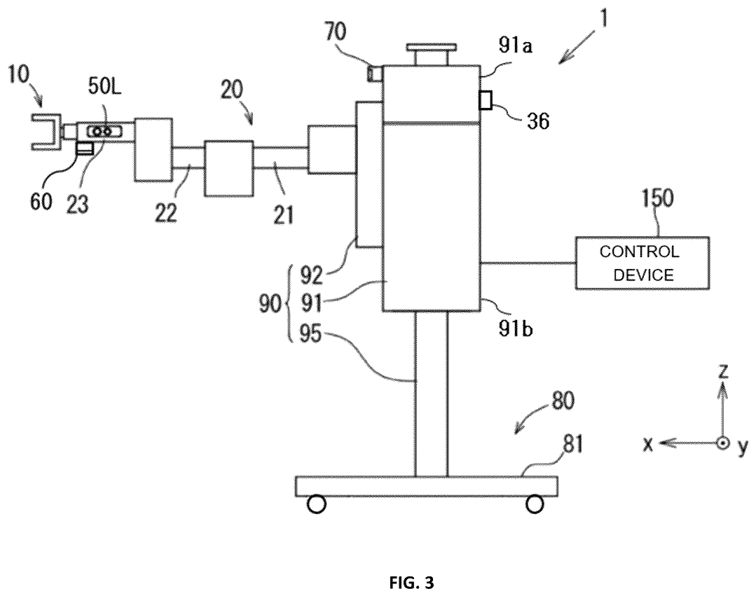

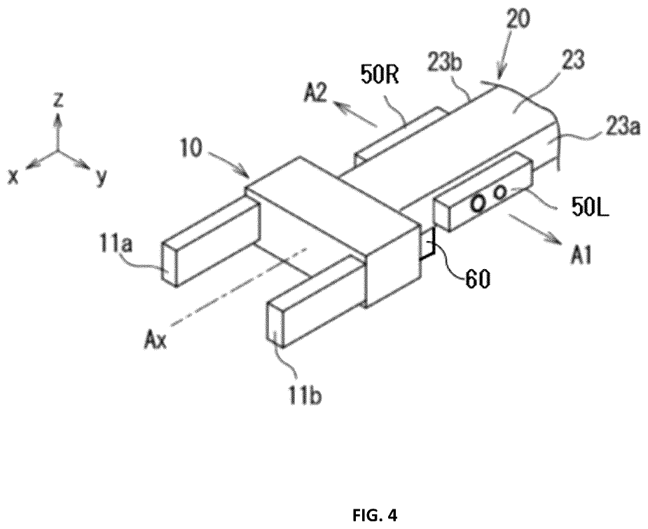

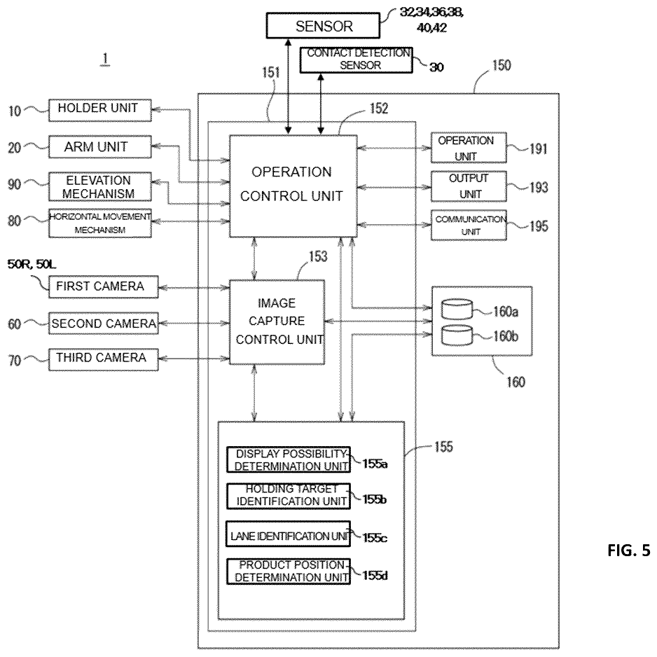

The product transfer apparatus 1 will be described with reference to FIG. 1, and 3 to 5. FIG. 3 is a side view schematically showing structure of the product transfer apparatus 1. FIG. 4 is a perspective view showing structure around a front end of an arm unit of the product transfer apparatus 1. FIG. 5 is a block diagram showing structure of the product transfer apparatus 1.

The product transfer apparatus 1 includes a holder unit 10, an arm unit 20, a contact detection sensor 30, first cameras 50R, 50L, a second camera 60, a third camera 70, a horizontal movement mechanism 80, an elevation mechanism 90, and a control device 150. The product transfer apparatus 1 is a robot which moves in a space between the product display shelf 410 and the stock shelf 420. The product transfer apparatus 1 holds a product T in the stock shelf 420 by the holder unit 10, and thereafter, moves the product T held by the holder unit 10 to a display position of the product of the product display shelf 410 (lane which displays the product T).

As shown in FIG. 4, the holder unit 10 includes a pair of holder members 11a, 11b for holding a target object. The pair of holder members 11a, 11b have a shape configured to hold the product T which is a PET bottle beverage at a position near the cap member Tb. Further, the pair of holder members 11a, 11b have a shape configured to hold an outer peripheral portion of the product T which is a canned beverage. The holder unit 10 may not be formed by the pair of holder members 11a, 11b. Alternatively, the holder unit 10 may be configured to hold a target object by adsorption or may be configured to hold a target object by using an adhesive force, a magnetic force, etc.

The arm unit 20 includes a plurality of link members 21, 22, 23. The plurality of link members 21, 22, 23 form a multi-joint robot arm. For example, the multi-joint robot arm may be a 6-axis arm with degrees of freedom in a straight direction along each of the X, Y, and Z axis directions, and with degrees of freedom in each of the directions about the X, Y, and Z axes. The multi-joint robot arm may have any other mechanism, such as an orthogonal coordinate system robot arm, a polar coordinate system robot arm, a cylindrical coordinate system robot arm, or a SCARA robot arm. One end of the arm unit 20 is fixed to the elevation mechanism 90. The holder unit 10 is provided at a front end of the arm unit 20. Operation of the arm unit 20 is controlled by the control device 150.

The arm unit 20 can move the holder unit 10 toward the stock shelf 420 or toward the product display shelf 410 by moving respective link members 21, 22, 23. The orientation of the arm unit 20 is not fixed to a certain direction. However, for the sake of explanation, the direction in which the respective link members 21, 22, 23 are extended will be referred to as the extension direction Ax of the arm unit 20 (see FIG. 4). The arm unit 20 moves the holder unit 10 forward toward the product T to hold the product T. The extension direction Ax of the arm unit 20 corresponds to the forward direction of the holder unit 10 in the holding operation.

An absolute encoder (not shown), which is an encoder outputting the absolute value of the rotation angle of each link member 21, 22, 23 of the arm unit 20, is provided at each joint which drives rotation of each link member 21, 22, 23. In general, even if rotation has occurred while the absolute encoder has not been activated, the absolute encoder can output the absolute value of the rotation angle at the time when the absolute encoder is turned on and activated. As the absolute encoder, optical and magnetic types are known, and the description about the detailed structure of the encoder is omitted herein. Since the lengths of the respective link members 21, 22, 23 of the arm unit 20 of the product transfer apparatus 1 are known, by integrating the rotational angles of the respective joints which drive rotation of the respective link members 21, 22, 23, outputted from the respective absolute encoders, the control device 150 can obtain the position of the front end of the arm unit 20 (the center position of the wrist portion of the holder unit 10) relative to the elevation mechanism 90 (in particular, the center of the elevation mechanism 90) on which the arm unit 20 is mounted. Thus, the absolute encoder provided at each joint functions as a sensor for obtaining posture information of the arm unit 20.

The contact detection sensor 30 is a sensor which detects that the product T held by the holder unit 10, the holder unit 10 or the arm unit 20 contacts an obstacle such as a wall or a pillar of the product display shelf 410 at the time of placing the product T held by the holder unit 10 on the shelf plate 411 of the product display shelf 410. For example, a torque sensor, an acceleration sensor, an inertial measurement unit (IMU), a motor input current sensor, etc. can be used as the contact detection sensor 30.

For example, a strain gauge can be used as a torque sensor to detect the torque generated in the shaft of each joint of the arm unit 20. Various types of acceleration sensors, such as capacitance type or piezoresistive type, mounted on the holder unit 10 or the arm unit 20 can be used as the acceleration sensors.

The inertial measurement unit (IMU) is a device which detects three-dimensional inertial motion (translational and rotational motion in three orthogonal axes), and the inertial measurement unit (IMU) is equipped with an acceleration sensor to detect translational motion and an angular velocity (gyro) sensor to detect rotational motion. Among these sensors, the gyro sensor can be used to detect angular velocity to obtain the angle or angular change of the target object. For example, in the case where gears or gears and toothed belts are used as drive transmission means for the wrist portion of the holder unit 10, the motion of the wrist portion of the holder unit 10 can have redundancy due to play between gears or stretching of the toothed belt. So, for example, during the operation of placing the product T held by the holder unit 10 on the shelf plate 411 of the product display shelf 410, in the state where the product T is in contact with the upper surface of the shelf plate 411, if an additional force is applied to the holder unit 10 by moving the arm unit 20 further, as a result, some displacement will be caused in the wrist portion of the holder unit 10, and the posture (i.e., angle) of the holder unit 10 changes. Therefore, such angular changes which may occur in the holder unit 10 during the operation of placing the product T on the shelf plate 411 can be detected by the IMU mounted on the holder unit 10 to detect that the product T has come into contact with the shelf plate 411.

In the case where a servomotor etc. is used to drive each joint of the arm unit 20, when an external force which causes an angle deviation from the angle at which the holding posture is maintained occurs, the servomotor operates to keep the angle deviation at zero in order to maintain the original angle. In the state where the product T held by the holder unit 10, the holder unit 10 or the arm unit 20 is in contact with an obstacle, such as a wall or a pillar of the product display shelf 410, at the time of moving the arm unit 20 further, current is inputted to the servomotor to drive the servomotor in opposition to the load. Therefore, by detecting the current inputted to the servomotor for such operation using the motor input current sensor, it is possible to detect that the product T held by the holder unit 10, the holder unit 10 or the arm unit 20 is in contact with an obstacle such as the wall or the pillar of the product display shelf 410. For example, the motor input current sensor may be in the form of a control unit 151 (see FIG. 5) described later.

Two first cameras 50R, 50L are provided on both of the left and right sides of the arm unit 20, respectively. The first camera 50L mounted on a first side surface 23a which is the left side of the arm unit 20 is oriented in a first orientation A1 along a direction perpendicular to the extension direction of the arm unit 20 (see FIG. 4). The first camera 50L is used for mainly capturing an image of the product display shelf 410. The first camera 50R mounted on a second side surface 23b which is the right side of the arm unit 20 in parallel to the first side surface 23a and opposite to the first side surface 23a is oriented in a second orientation A2 which is opposite to the first orientation A1. The first camera 50R is used for mainly capturing an image of the stock shelf 420. As described above, the first cameras 50R, 50L are disposed in opposite directions to each other.

Therefore, while keeping the arm unit 20 in the same posture, it is possible to capture images of the product display shelf 410 and the stock shelf 420 by the first cameras 50R, 50L, respectively, at the same time.

The performance of the first camera 50R and the performance of the first camera 50L may be the same, or may be different. Hereinafter, for the purpose of brevity of description, an example where both of the cameras have the same performance will be described. It should be noted that the purpose and/or the condition of capturing the image of the product display shelf 410 and the purpose and/or the condition of capturing the image of the stock shelf 420 are different. Therefore, it is a matter of course that cameras having different performances may be used depending on the respective purposes and conditions.

For example, the first cameras 50R, 50L may have an image capture element and a depth sensor. The image capture element generates a capture image (RGB image in one example) in which pixels are arranged in two dimensions. The depth sensor is a distance detection device for generating distance data. The depth sensor is not limited to a certain type as long as the depth sensor is capable of obtaining data of the distance to the target object. For example, the depth sensor may use a stereo lens system or a LiDAR (Light Detection and Ranging) system. For example, the depth sensor may generate Depth images. In other embodiments of the present disclosure, either or both of the first cameras 50R, 50L may, for example, utilize an ultrasonic element to obtain the distance data.

It should be noted that the first camera 50L is oriented in the first orientation A1. This means that the image capture direction of the image capture element and the depth sensor of the first camera 50L is the orientation A1. Likewise, the second camera 60 is oriented in the second orientation A2. This means that the image capture direction of the image capture element and the depth sensor of the first camera 50R is in the orientation A2. The orientations A1 and A2 do not necessarily have to be 180° opposites to each other, as long as the orientations A1 and A2 allow image capturing of the product display shelf 410 and the stock shelf 420.

One or both of the first cameras 50L, 50R may be provided on the holder unit 10. The first cameras 50L, 50R may not necessarily be provided on the same member. For example, the first camera 50R may be mounted on one of the link members 21 to 23, and the first camera 50L may be mounted on another one of the link members 21 to 23. However, in the case where the first cameras 50L, 50R are provided on the same member, in comparison with the case where the cameras 50L, 50R are provided on separate link members, respectively, there is an advantage that image processing computation is simplified because a common coordinate system is used.

The second camera 60 is used to capture an image showing the state where the holder unit 10 holds the product T, and the relative positional relationship between the product T held by the holder unit 10 and the shelf plate 411 of the product display shelf 410. As in the case of the first cameras 50R, 50L, the second camera 60 may have an image capture element and a depth sensor. The image capture element generates a capture image (RGB image in one example) in which pixels are arranged in two dimensions. The depth sensor generates distance data.

For example, the second camera 60 may be provided below the link member 23 closest to the holder unit 10, among the link members 21 to 23 of the arm unit 20, at a position close to the holder unit 10. The image capturing direction of the imaging element and the depth sensor of the second camera 60 are oriented directly downward (in the −z direction in FIGS. 3 and 4) or downward forward (somewhat more +x direction than in the −z direction in FIGS. 3 and 4) of the link member 23 and the holder unit 10. In the structure, the second camera 60 can capture an image of at least a lower portion of the product T held by the holder unit 10 and the shelf plate 411 positioned on the front side of the holder unit 10.

The third camera 70 is a camera for capturing an image of a predetermined target object by changing the orientation, e.g., in accordance with operation of an operator at a remote location. For example, the third camera 70 is mounted on part of the elevation mechanism 90. The third camera 70 is capable of moving horizontally and vertically in a space between the product display shelf 410 and the stock shelf 420, in accordance with operation of the horizontal movement mechanism 80 and the elevation mechanism 90. Further, the portion of the elevation mechanism 90 on which the third camera 70 is mounted is rotatable about a pillar 95, and the third camera 70 is configured to rotate and move in the left-right direction about the pillar 95 as the portion rotates, and capture the image of the product display shelf 410 and capture the image of the stock shelf 420 as necessary.

For example, the third camera 70 may adopt a stereo lens system. Although not limited, the third camera 70 may have a wide angle of view in comparison with the first cameras 50L, 50R and the second camera 60.

The horizontal movement mechanism 80 has a base plate 81 and a drive mechanism (not shown). The base plate 81 supports the elevation mechanism 90, and slides along the rails R (see FIG. 1) provided between the product display shelf 410 and the stock shelf 420 in the store. The drive mechanism (not shown) includes a motor, a roller, etc., and operates based on a control signal from the control device 150 (see FIG. 5) to move the elevation mechanism 90 to a predetermined position along the rails.

At or near both ends of the base plate 81 in the movement direction along the rails (left and right ends in the X direction shown in the drawing), an end detection sensor 32 (see FIG. 5) is provided to detect that the base plate 81 has reached a first position, which is an end in one direction of the rails R (see FIG. 1), or a second position, which is an end in the other direction. As the end detection sensor 32, for example, a limit switch which electrically or mechanically detects contact with a contact portion (not shown) provided near both ends of the rails R (see FIG. 1), or an optical sensor which detects retroreflected light by a reflector plate provided near both ends of the rails R (see FIG. 1) can be used. Since the base plate 81 has such an end detection sensor 32, in the case where the base plate 81 moves along the rails R and the end detection sensor 32 detects a detection target portion (the contact portion and the reflector plate described above, etc.) on the rails R, it becomes possible to stop movement of the base plate 81 to prevent the base plate 81 from moving further and deviating from the rails R. Further, it is also possible to calibrate the position of the base plate 81 on the rails R by intentionally moving the base plate 81 in one of the directions toward the ends of rails R until the end detection sensor 32 detects the detection target portion provided on the rails R.

The elevation mechanism 90 has the pillar 95, a first elevation mechanism 91 as a main body, and a second elevation mechanism 92. The pillar 95 is fixed on the base plate 81 and extends in the vertical direction.

The first elevation mechanism 91 has a drive mechanism (not shown). The drive mechanism (not shown) includes a motor and a linear guide, and operates based on a control signal from the control device 150 (see FIG. 5). By operating the drive mechanism (not shown), the first elevation mechanism 91 moves vertically up and down along the pillar 95, and is driven to rotate in the left-right direction about the pillar 95. Further, an upper portion 91a as a first main body part of the first elevation mechanism 91 on which the third camera 70 is mounted is configured to be driven to rotate in the left-right direction about the pillar 95 relative to a lower portion 91b as a second main body part of the first elevation mechanism 91. The above described third camera 70 is mounted on the upper portion 91a of the first elevation mechanism 91, and functions as a head of the product transfer apparatus 1 which is rotatable in the left-right direction.

The first elevation mechanism 91 is provided with a sensor 40 (see FIG. 5) for detecting the reference position height of the pillar 95. For example, the first elevation mechanism 91 is provided with an electric or mechanical limit sensor as the sensor 40, and a detection target portion (not shown), such as a contact portion, is provided at a predetermined reference height position in the vertical direction of the pillar 95. By moving the first elevation mechanism 91 in the vertical direction relative to the pillar 95 until detection by the sensor 42 and the detection target portion is performed, it is possible to perform alignment and calibration of the first elevation mechanism 91 relative to the reference height position of the pillar 95. For example, the sensor 40 is configured to detect an upper limit position and a lower limit position of the first elevation mechanism 91 relative to the pillar 95.

A sensor 34 (see FIG. 5) for detecting a reference position of the pillar 95 in a rotation direction about the pillar 95 is provided on the upper portion 91a of the first elevation mechanism 91. For example, as the sensor 34, a limit switch which mechanically or electrically detects contact with a contact portion (not shown) provided at a predetermined reference position of the pillar 95, an optical sensor for detecting a retroreflected light using a reflection plate provided at the predetermined reference position of the pillar 95 may be used. Since the upper portion 91a of the first elevation mechanism 91 has such a sensor 34, the sensor 34 can calibrate the position of the upper portion 91a of the elevation mechanism in the rotation direction relative to the reference position of the pillar 95, by driving rotation of the upper portion 91a about the pillar 91a until the sensor 34 detects the detection target portion provided at the reference position of the pillar 95 (the above described contact portion, the reflection plate, etc.).

Further, a sensor 36 (see FIG. 5) for detecting the relative position of the lower portion 91b relative to the upper portion 91a of the first elevation mechanism 91 in the rotation direction about the pillar 95 is provided on the upper portion 91a or the lower portion 91b of the first elevation mechanism 91. As the sensor 36, for example, a magnetic sensor is provided on one of the upper portion 91a and the lower portion 91b, and a magnet (not shown) as a detection target portion detected by the magnetic sensor is provided on the other of the upper portion 91a and the lower portion 91b. As the magnetic sensor, for example, a Hall sensor which applies the Hall effect can be used. The Hall sensor converts the strength and direction of the magnetic field into a voltage value which is either positive or negative. For example, by rotating the lower portion 91b relative to the upper portion 91a about the pillar 95 until the magnetic sensor detects the magnet, it is possible to detect that the upper portion 91a and the lower portion 91b are positioned at locations where positions in the rotation direction of the magnetic sensor 36 and the magnet are aligned with each other. As the sensor 36, instead of the magnetic sensor, an optical sensor or a limit switch may be used.

Further, a distance measurement sensor 38 (see FIGS. 3 and 5) for measuring a distance between the equipment around the product transfer apparatus 1 (in particular, walls positioned in extension directions of both ends of the rails R) and the product transfer apparatus 1 is provided on the upper portion 91a of the first elevation mechanism 91. As the distance measurement sensor 38, for example, a reflection type laser sensor of a ToF (Time of Flight) system can be used. The reflective type sensor of the ToF system can measure the distance to the surface of the target object, based on the time it takes for a pulsed laser beam to be reflected and returned by the surface of the target object. The upper portion 91a of the first elevation mechanism 91 has a distance measurement sensor 36 of such a type. So, by orienting the distance measurement sensor 38 in one longitudinal direction of the rails R to measure the distance to the wall positioned in the one longitudinal direction, and the upper portion 91a is rotated in a manner that the distance measurement sensor 38 is oriented to the other longitudinal direction of the rails R to measure the distance to the wall positioned in the other longitudinal direction, it is possible to measure the distance to each wall positioned at each end of the rails R in both longitudinal directions.

The second elevation mechanism 92 is held by the first elevation mechanism 91. One end of the arm unit 20 is attached to the second elevation mechanism 92. The second elevation mechanism 92 has a drive mechanism (not shown). The drive mechanism (not shown) includes a motor and a linear guide, and operates based on a control signal from the control device 150 (see FIG. 5). By operating the drive mechanism (not shown), the first elevation mechanism 91 moves vertically up and down along the pillar 95.

The first elevation mechanism 91 or the second elevation mechanism 92 is provided with the sensor 42 (see FIG. 5) for detecting a relative position in the vertical direction of the second elevation mechanism 92 relative to the first elevation mechanism 91. As the sensor 42, for example, a magnetic sensor, an optical sensor, an electrical or mechanical limit sensor is provided for one of the first elevation mechanism 91 and the second elevation mechanism 92, and detection target portions (not shown) such as a magnet, a reflection plate, a contact portion are provided for the other of the first elevation mechanism 91 and the second elevation mechanism 92. By moving the second elevation mechanism 92 in the vertical direction relative to the first elevation mechanism 91 until detection by the sensor 42 and the detection target portion is performed, it is possible to position the second elevation mechanism 92 at the reference height position of the first elevation mechanism 91. For example, the sensor 42 and the detection target portion are configured to detect the upper limit height and the lower limit height of the second elevation mechanism 92 relative to the first elevation mechanism 91.

In the case of holding a product T which is present at a predetermined height, the elevation mechanism 90 moves the arm unit 20 and the holder unit 10 by the first elevation mechanism 91 to a height around which the product T can be held, and finely adjusts the height of the arm unit 20 and the holder unit 10 by the second elevation mechanism 92.

In the present embodiment, the first elevation mechanism 91 and the second elevation mechanism 92 are provided as elevation mechanisms. However, in other embodiments of the present invention, only one elevation mechanism may be provided.

### Structure of the Control Device 150

As shown in FIG. 5, the control device 150 has the control unit 151, a memory unit 160, an input unit 191, an output unit 193, and a communication unit 195. In FIG. 5, though the control device 150 is drawn as a single element, the control device 150 does not necessarily have to be a physically single element, but may be composed of a plurality of elements that are physically separated from each other.

The input unit 191 is a device for receiving input from the operator. The input unit 191 may be made up of devices such as a keyboard, a mouse, a touch panel, etc. for providing input to a computer. The input unit 191 may have an audio input device such as a microphone. The input unit 191 may have a gesture input device which recognizes and identifies operator's movements through image recognition.

The output unit 193 is used for allowing the product transfer apparatus 1 to output an alert to a store employee, etc. For example, the output unit 193 is made up of one of, or a combination of devices such as a speaker, a display, a light-emitting deice, and a vibration device. The communication unit 195 has a function of receiving data from the outside and transmitting data to the outside. In the case where the product transfer apparatus 1 is configured to be operated remotely, an input from the operator through an operation unit of an external device (not shown) is received by the communication unit 195, and the control device 150 allows the product transfer apparatus 1 to perform a predetermined operation based on the input. Communication between the operation unit of the external device and the communication unit 195 may be either wired communication or wireless communication.

In the case where the product transfer apparatus 1 is configured to be operated remotely, the operation unit 191 may be a device worn by the operator. The device includes a display device (not shown) and an operation device (not shown). The display device has a display which is visible to the operator. For example, the display device may be a head mount display (HMD). For example, the operation device may include one or more input sensors which can detect movement of the operator's body parts (e.g., hands and arms).

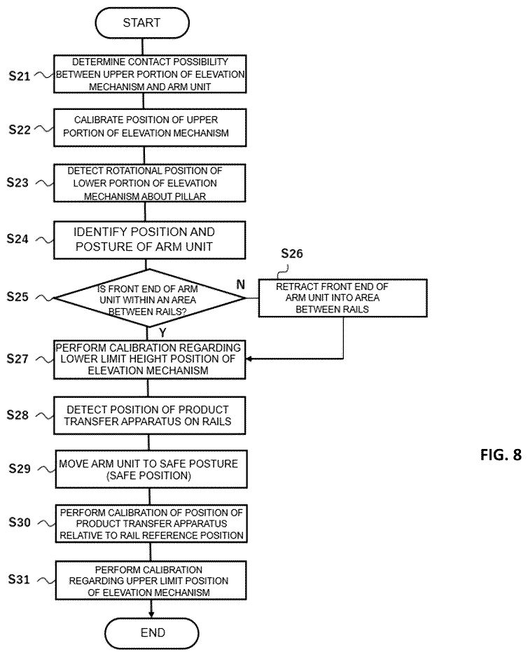

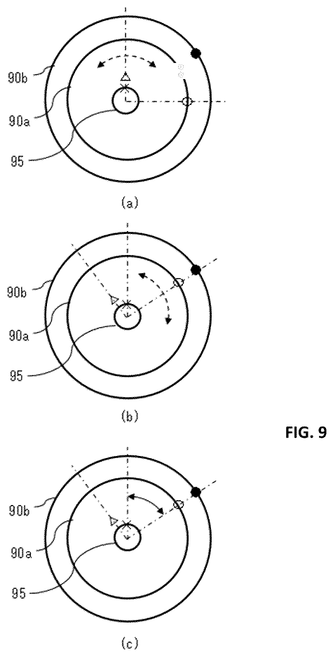

The memory unit 160 includes a transitory or non-transitory storage medium such as a ROM (Read Only Memory), a RAM (Random Access Memory) and an HDD (Hard Disk Drive). The memory unit 160 stores computer programs executed by the control unit 151, and/or learned models, etc., which will be described later. The computer programs stored in the memory unit 160 includes an instruction for performing a method of controlling the product transfer apparatus 1 by the control unit 151, which will be described later with reference to FIGS. 8 and 9, etc.

The memory unit 160 includes an acquisition data memory unit 160a and a reference data memory unit 160b. The acquisition data memory unit 160a stores capture image data, etc. captured by each of the cameras 50R, 50L, 60, 70. The reference data memory unit 160b stores various items of data necessary for operation of the product transfer apparatus 1. The various items of data include data regarding the product display shelf 410 and the stock shelf 420 (various items of shape data, position data, or lane coordinate data, etc.), and data regarding the product T (shape data, position data, etc.). In particular, in the present embodiment, the data regarding the distance between the central position of each lane on each shelf plate 411 of the product display shelf 410 and the left and right partition plates 412 is stored in the reference data memory unit 160b.

For example, the control unit 151 is made up of one, or two or more CPUs (Central Processing Unit). The control unit 151 functions as an operation control unit 152, an image capture control unit 153, and an image data processing unit 155 by executing a computer program stored in the memory unit 160.

The operation control unit 152 generates control signals for operating each of the holder unit 10, the arm unit 20, the horizontal movement mechanism 80, the elevation mechanism 90, and the control device 150. The operation control unit 152 generates the control signals with reference to input signals from the operation unit 191 and/or various items of data stored in the memory unit 160. Generation of the control signal may be performed by using the processing results of the image data processing unit 155. The operation control unit 152 transmits/receives data via the communication unit 195, and generates a predetermined output via the output unit 193.

The image capture control unit 153 controls operation of each of the cameras 50R, 50L, 60, 70. The image capture timing, etc. of each of the cameras 50R, 50L, 60, 70 may be determined using data stored in the reference data memory unit 160b in advance.

The image data processing unit 155 performs various items of information processing using capture image data and the distance data (depth data) captured by image capturing by each of the cameras 50R, 50L, 60, 70. For example, the image data processing unit 155 analyzes an image of image data captured by the first camera 50R, and identifies the products arranged on the stock shelf 420. The image data processing unit 155 has a display possibility determination unit 155a, a holding target identification unit 155b, a lane identification unit 155c, and a product position identification unit 155d.

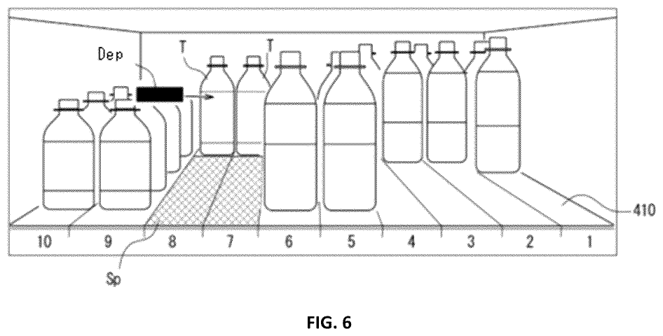

Based on at least one of the capture image data generated by image capturing of the first camera 50L and the distance data, the display possibility determination unit 155a determines, for example, whether or not a space Sp (see FIG. 6) is present to place more products behind the rearmost product T arranged on the product display shelf 410. FIG. 6 shows an image of the product display shelf 410 captured by the first camera 50L of the product transfer apparatus 1. If a space Sp is present, it means that the product T needs to be replenished. Therefore, if the space Sp is present, the display possibility determination unit 155a transmits a notification indicating that the product T should be replenished on the shelf plate 411 below the space Sp, to the operation control unit 151. In the case where the operation control unit 151 receives this notification, the operation control unit 151 performs replenishment operation for the product T.

Based on at least one of the capture image data captured by the first camera 50R and the distance data, the holding target identification unit 155b performs at least one of determination of whether or not the replenishment target product as a holding target is present in the stock shelf 420, identification of the size or shape of the replenishment target product, and determination of a holding position of the replenishment target product. In the case where the product T has the cap member Tb as shown in FIG. 1, for example, the holding target identification unit 155b sets a position near the cap member Tb as the holding position. In the case where the product T does not have the cap member Tb, the holding target identification unit 155b may set a side portion of the container as the holding position.

The lane identification unit 155c analyzes an image of the back side of the product display shelf 410 captured by the product transfer apparatus 1, and identifies the coordinate of each lane on the shelf plate 411 and the central position of each lane (central position in the width direction of each lane). Further, the lane identification unit 155c may identify the coordinate of the product T on the product display shelf 410. Further, the lane identification unit 155c may add an image of a dot, etc., at a position in the image corresponding to the identified coordinate.

The product position identification unit 155d analyzes image data of a capture image captured by the second camera 60 when the product T held by the holder unit 10 moves to a position above the product placement position (lane of the placement target) of the shelf plate 411 of the product display shelf 410, and identifies the positional relationship in a direction in which a plurality of lanes are arranged, between a reference position of the lane for placing the product of the shelf plate 411 and the product placed above the lane.

### Product Replenishment Operation by the Product Transfer Apparatus 1

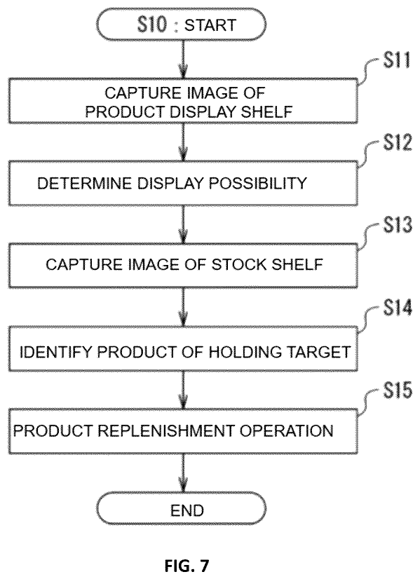

FIG. 7 is a flow chart showing operation of replenishing the product T by the product transfer apparatus 1.

Firstly, in step S11, the first camera 50L mounted on the arm unit 20 of the product transfer apparatus 1 captures an image of the back side of the product display shelf 410. The product transfer apparatus 1 moves the arm unit 20, the horizontal movement mechanism 80, and the elevation mechanism 90 in a manner that an image of each level of the product display shelf 410 can be captured by the first camera 50L. Next, the product transfer apparatus 1 operates the first camera 50L to obtain an image of the back side of the product display shelf 410, and obtain the data of distance (distance data) to the product T arranged on the product display shelf 410.

Next, in step S12, display possibility determination is made. The “display possibility determination” is a step performed by the display possibility determination unit 155a in the image data processing unit 155 of the product transfer apparatus 1 to determine which products T can be displayed (in other words, which products T need to be replenished) on which shelf plate 411 by analyzing the captured image of the back side of the product display shelf. The product transfer apparatus 1 obtains the image of the back side of the product display shelf 410 as shown in FIG. 6.

The lane identification unit 155c in the image data processing unit 155 of the product transfer apparatus 1 identifies the lane on the shelf plate 411 of the product display shelf 410 using the capture image data captured by the first camera 50L. Further, since the image data processing unit 155 of the product transfer apparatus 1 can obtain data of the distance to the product T (depth data Dep visually shown in FIG. 6), it is possible to recognize the presence of a space Sp behind the product T for items such as the products T in lanes “7” and “8”, where the number of displayed products has been decreased. The display possibility determination unit 155a of the product transfer apparatus 1 determines whether or not there is the space Sp for the product T based on the data of the distance to the product T, and whether or not more products T can be displayed in the lanes “7” and “8”. By the process of step S12, it is determined which products T need to be replenished on which shelf plate 411 of the product display shelf 410.

It should be noted that the method of determining whether or not products need to be replenished is not limited to the method described above, and various methods can be used. For example, it may be possible to determine what percentage of the products T are arranged in a predetermined three-dimensional space and determine that the products T need to be replenished if the value is a predetermined standard value or less.

Next, in step S13, the image of the stock shelf 420 is captured. The product transfer apparatus 1 operates the arm unit 20, the horizontal movement mechanism 80, the elevation mechanism 90, and the first camera 50R to capture the image of the stock shelf 420 from the front side. For example, the product transfer apparatus 1 captures an image of the stock shelf 420 one level at a time, and obtains the capture image indicating the stock condition of the product T. It is not essential to perform image capturing of the stock shelf 420 after the image of the product display shelf 410 is captured, and image capturing of the stock shelf 420 may be performed before the image of the product display shelf 410 is captured.

Next, in step S14, the image data processing unit 155 of the product transfer apparatus 1 analyzes the capture image of the stock shelf 420 obtained in step S13 to identify the products arranged on the stock shelf 420. Further, the holding target identification unit 155b of the image data processing unit 155 identifies the holding position of the product. By the processes up to this point, information indicating which products T at which positions of which shelf plate 411 of the product display shelf 410 need to be replenished, information indicating the positions of the replenishment target products on the stock shelf 420 corresponding to the products T, and the holding positions of the replenishment target products are obtained by the product transfer apparatus 1.

Next, in step S15, the product transfer apparatus 1 performs product replenishment operation (pick-and-place operation) based on the above obtained information. Specifically, the operation control unit 152 of the control unit 151 of the product transfer apparatus 1 (see FIG. 5) operates the arm unit 20, the horizontal movement mechanism 80, and the elevation mechanism 90 to move the holder unit 10 toward a predetermined replenishment target product on the stock shelf 420. Then, the holder unit 10 holds the previously identified holding position of the replenishment target product, and, lifts the replenishment target product. Then, the operation control unit 152 operates the arm unit 20, the horizontal movement mechanism 80, and the elevation mechanism 90 to move the held product T to a predetermined placement position on the product display shelf 410, and releases the product T from the holder unit 10 to place the product T at a predetermined position.

Thereafter, the product transfer apparatus 1 repeats the pick-and-place operation in the same manner to complete replenishment of the products T.

The above series of processes are the basic operations of the product transfer apparatus 1 for automatically replenishing the products T from the stock shelf 420 to the product display shelf 410. In the product transfer apparatus 1, before starting operation of the product transfer apparatus 1 by restarting the stopped system, at the time point, it is required for the system to recognize the positions and the postures of the product transfer apparatus 1 and parts of the product transfer apparatus 1. If operation of the product transfer apparatus 1 is started without recognizing these positions and the postures, depending on the positions and postures at the time of restarting, the operation of driving each component at the time of starting operation of the product transfer apparatus 1 may cause collision of the holder unit 10 or the arm unit 20 with the product display shelf, etc., and may damage the holder unit 10 or the arm unit 20. The present embodiment provides means for preventing damages of the product transfer apparatus and equipment around the product transfer apparatus, at the time of starting operation the product transfer apparatus by restarting.

### Operation Example

FIG. 8 is a flow chart illustrating one operation example of the product transfer apparatus 1 according to the present embodiment.

Firstly, in step S21, the distance between the upper portion 91a (head) of the first elevation mechanism 91 of the product transfer apparatus 1 and the central part of the front end of the arm unit 20 of the first elevation mechanism 91 of the product transfer apparatus 1 (corresponding to a wrist portion of the arm unit 20) is determined, and it is determined whether or not there is a possibility of contact between the upper portion 91a (head) and the central part of the front end of the arm unit 20. In step S21, the control unit 151 of the product transfer apparatus 1 obtains the position of the front end of the arm unit 20 (central position of the wrist portion of the holder unit 10) relative to the center of the elevation mechanism 90. As described above, this position can be obtained by the control unit 151 integrating the rotation angle of each joint which drives rotation of each link member 21, 22, 23, outputted from each of absolute encoders. In the case where the distance between the central position of the elevation mechanism 90 and the position of the front end of the arm unit 20 is not less than a predetermined distance, the control unit 151 determines that there is no possibility of contact between the upper portion 91a (head) and the central part of the front end of the arm unit 20, and proceeds to step S22.

Next, in step S22, the operation control unit 152 of the control unit 151 (see FIG. 5) of the product transfer apparatus 1 calibrates the position of the upper portion 91a (head) of the first elevation mechanism 91 of the product transfer apparatus 1 relative to the reference position in the rotation direction about the pillar 95.

FIG. 9 is a view conceptually showing the positional relationship between the upper portion 91a and the lower portion 91b of the elevation mechanism 91 in the rotation direction about the pillar 95. As shown in FIG. 9(a), for example, the operation control unit 152 rotates the upper portion 91a of the elevation mechanism 91 in one direction about the pillar 95 by at least one rotation or rotates the upper portion 91a of the elevation mechanism 91 in both left and right directions each by at least half a rotation. During these rotation operations, the sensor 34 (“x (cross)” mark in FIG. 9) provided on the upper portion 91a of the elevation mechanism 91 detects the detection target portion provided at a predetermined reference position of the pillar 95 (“Δ (triangle)” mark in FIG. 9). In this manner, the operation control unit 152 detects the position of the upper portion 91a relative to the reference position in the rotation direction about the pillar 95, and calibrates the detected position as the origin position of the upper portion 91a in the rotation direction about the pillar 95.

Next, in step S23, the operation control unit 152 detects the position in the rotation direction about the pillar 95, of the lower portion 91b of the elevation mechanism 91 of the product transfer apparatus 1. As shown in FIG. 9(b), the operation control unit 152 rotates the upper portion 91a of the elevation mechanism 91 in one direction about the pillar 95 by at least one rotation or rotates the upper portion 91a of the elevation mechanism 91 in both left and right directions each at least half a rotation. During these rotation operations, the sensor 36 provided on the upper portion 91a or the lower portion 91b of the first elevation mechanism 91 detects the position of the lower portion 91b in the rotation direction about the pillar 95. For example, in the case of using a Hall sensor as the sensor 36, the output voltage increases as the Hall sensor provided on one of the upper portion 91a and the lower portion 91b (for example, a “o” mark in FIG. 9 provided on the upper portion 91a) and the magnet provided on the other of the upper portion 91a and the lower portion 91b (for example, a “⋅” mark in FIG. 9 on the lower portion 90b) approach each other, and the output voltage decreases as the Hall sensor and the magnet move away from each other, from the closest position. Therefore, it is possible to detect the position where the output voltage obtained from the Hall sensor during rotation of the upper portion 90a becomes a peak as a position where the relative positions in the rotation direction of the upper portion 91a and the lower portion 91b are aligned with each other.

In the above step S22, the position of the upper portion 91a relative to the reference position in the rotation direction about the pillar 95 is detected, and the position is calibrated as the origin position. Therefore, the operation control unit 152 calculates the position detected in step S22 where the upper portion 91a and the lower portion 91b are aligned with each other in the rotation direction, determining how many degrees and in which direction (left or right) the upper portion 90a has been rotated from the origin position of the upper portion 91a (see FIG. 9(c)). Based on this calculation, the operation control unit 152 can obtain data indicating how many degrees and in which direction(left or right) the lower portion 91b of the first elevation mechanism 91 has been moved from the reference position in the rotation direction about the pillar 95. It should be noted that the positional relationship between the sensors 34, 36 on the upper portion 91a is known in the system of the product transfer apparatus 1, and stored in the memory unit 160, for example.

Next, in step S24, the operation control unit 152 identifies the position and the posture of the arm unit 20 of the product transfer apparatus 1. The rotation angle of each joint for driving rotation of each link member 21, 22, 23 can be obtained by the absolute encoder provided on each joint as described above, and the length dimension, etc. of each link member 21, 22, 23 is known in the system of the product transfer apparatus 1, and stored in the memory unit 160, for example. Further, in step S23, the operation control unit 152 obtains data indicating how many degrees and in which direction (left or right) the lower portion 91b of the first elevation mechanism 91 where the arm unit 20 is provided has been moved from the reference position in the rotation direction about the pillar 95. Therefore, based on these items of information, the operation control unit 152 can calculate, and obtain the position and posture of the arm unit 20 relative to the product transfer apparatus 1.

Next, in step S25, the operation control unit 152 determines whether or not the position of the arm unit 20 is located within an area between the two rails R of the track on the floor between the product display shelf 410 and the stock shelf 420 in the store. In the system of the product transfer apparatus 1, the positional relationship between the product transfer apparatus 1 and the two rails R for the product transfer apparatus 1 is known, and stored in the memory unit 160, for example. Therefore, the operation control unit 152 can determine whether or not the position of the arm unit 20 obtained in step S24 is located within the area between the two rails R. If the position of the arm unit 20 is located within the area between the two rails R, when operation of moving the product is started afterward, it is considered that the arm unit 20 is located at a safe position where the arm unit 20 and the holder unit 10 do not contact the shelves 410, 420 inadvertently.

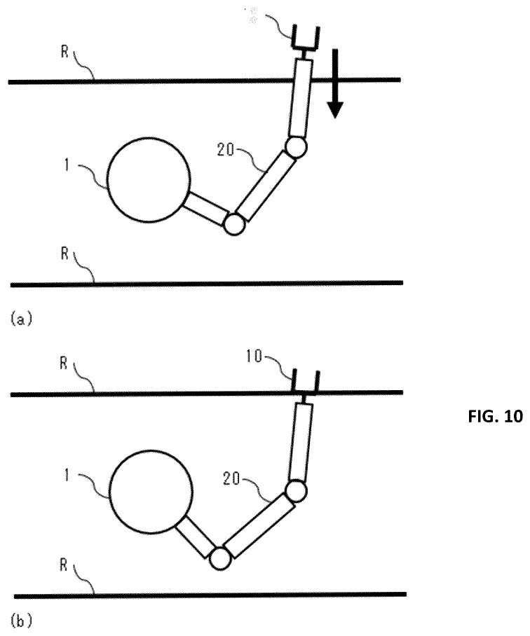

In step S25, if it is determined that the arm unit 20 is not located within the area between the two rails R (N), the process proceeds to step S26, and in step S26, the operation control unit 152 drives the arm unit 20 to retract the arm unit 20 into the area between the two rails R. Preferably, the operation of retracting the arm unit 20 into the area between the two rails R is performed, as shown in FIG. 10, for example, by driving rotation of each joint of the arm unit 20 and the lower portion 91b of the first elevation mechanism 91 in a manner that the arm unit 20 moves in a direction perpendicular to the longitudinal direction of the rails R. As described above, by moving the arm unit 20 in the direction perpendicular to the longitudinal direction of the rails R, and retracting the arm unit 20 into the area between the two rails R, even if part of the arm unit 20 or the holder unit 10 is located between the upper and lower shelf plates of the shelves 410, 420, it is possible to reduce the possibility that the part of the arm unit 20 or the holder unit 10 contacts the shelf plates or part of the pillar, etc. of the shelves 410, 420 during retraction operation of the arm unit 20.

In step S25, if it is determined that the arm unit 20 is located within the area between the two rails R (Y), or in step S26, when operation of retracting the arm unit 20 into the area between the two rails is performed, the process proceeds to step S27. In step S27, the operation control unit 152 moves the second elevation mechanism 92 downward in the vertical direction relative to the first elevation mechanism 91, until detection that the second elevation mechanism 92 is positioned at the lower limit height by the sensor 42 and the detection target portion, and the operation control unit 152 performs calibration regarding the lower limit height position of the second elevation mechanism 92 relative to the first elevation mechanism 91. Then, in step S27, the operation control unit 152 moves the first elevation mechanism 91 downward along the pillar 95, until the lower sensor of the sensor 40 detects that the first elevation mechanism 91 is positioned at the lower limit height, and the operation control unit 152 performs calibration regarding the lower limit height position of the first elevation mechanism 91 relative to the pillar 95.

Next, in step S28, the operation control unit 152 measures the distance from the product transfer apparatus 1 to the walls located on the extensions of both ends of the rails R, and obtains the position of the product transfer apparatus 1 on the rails R. In the system of the product transfer apparatus 1, the relationship between the direction of the reference position in the rotation direction about the pillar 95 and the longitudinal direction of the two rails R is known, and this relationship is stored in the memory unit 160, for example. Therefore, the operation control unit 152 drives rotation of the upper portion 90a so that the distance measurement sensor 38 provided on the upper portion 90a of the elevation mechanism 90 faces one longitudinal direction of the two rails R, and operates the distance measurement sensor 38 to measure the distance to the wall located on the extension of the rails R in the direction. Then, by driving rotation of the upper portion 90a so that the distance measurement sensor 38 faces the other longitudinal direction of the two rails R to measure the distance to the wall on the extension in the direction, it is possible to measure the distance to the wall located on each of the extensions of both ends of the rails R. Then, by driving rotation of the upper portion 90a so that the distance measurement sensor 38 faces the other longitudinal direction of the two rails R and measures the distance to the wall on the extension in the direction, it is possible to measure the distances to the walls located respectively on the extensions of both ends of the rails R.

In the system of the product transfer apparatus 1, the distance from one end of the two rails R to the wall in the extension direction of the rails R, and the distance from the other end of the two rails R to the wall in the extension direction the rails R, and the length of the two rails R (distance between both ends of the two rails R) are known, and these items of information are also stored in the memory unit 160. Therefore, the operation control unit 152 can obtain the position of the product transfer apparatus 1 on the rails R based on the respective distances to both walls measured as described above and the above known information. For example, the position of the center of the pillar 95 of the product transfer apparatus 1 may be used to represent the position of the product transfer apparatus 1 on the rails R.

Next, in step S29, the operation control unit 152 moves the arm unit 20 to a safe posture (safe position). The safe posture of the arm unit 20 is a state where the respective link members of the arm unit 20 are folded so that the arm unit 20 is positioned near the elevation mechanism 90. If the product transfer apparatus 1 is moved in the state where the arm unit 20 is extended, there is a risk that the front end of the arm unit 20 may contact the shelf or the wall. However, by operating the arm unit 20 to have such a safe posture, it is possible to reduce the risk of such contact.

Next, in step S30, the operation control unit 152 operates the horizontal movement mechanism 80 to move the product transfer apparatus 1 in one of the directions along the rails R, and detects and calibrates the position of the product transfer apparatus 1 relative to the reference position on the rails R. The operation control unit 152 moves the product transfer apparatus 1 along the rails R until the end detection sensor 32 detects the detection target portion provided near both ends of the rails R, and calibrates the position of the product transfer apparatus 1 on the rails R based on the reference position where the end detection sensor 32 detected the detection target portion.

Lastly, in step S31, the operation control unit 152 moves the first elevation mechanism 91 upward along the pillar 95 until the upper sensor of the sensor 40 detects that the first elevation mechanism 91 is located at the upper limit position, and performs calibration regarding the upper limit position of the first elevation mechanism 91 relative to the pillar 95. Further, in step S29, the operation control unit 152 moves the second elevation mechanism 92 upward in the vertical direction relative to the first elevation mechanism 91 until detection that the second elevation mechanism 92 is positioned at the upper limit height by the sensor 42 and the detection target portion, and performs calibration regarding the upper limit height position of the second elevation mechanism 92 relative to the first elevation mechanism 91.

In this manner, calibration regarding the position in the rotation direction and the vertical direction of the first elevation mechanism 91 relative to the pillar 95, the position in the rotation direction and the vertical direction of the second elevation mechanism 92 relative to the first elevation mechanism 91, the position (posture) of the arm unit 20, and the position of the product transfer apparatus 1 on the rails R is finished. When the above series of operations are finished, the product transfer apparatus 1 is placed at a home position at one of the ends of the rails R with the arm unit 20 in the safe posture. From this home position, the product transfer apparatus 1 starts operation of moving the product as described above.

As described above, in the present embodiment, after identifying that arm unit 20 is placed in the area between the rails R for the product transfer apparatus 1 or after moving the arm unit 20 into the area between the rails R, a calibration operation which involves movement of the elevation mechanism 90 of the product transfer apparatus 1 in the upper/lower direction and the movement of the horizontal movement mechanism 80 on the rails R is performed.

Identification that the arm unit 20 is placed in the area between the rails R can be performed by rotating the upper portion 90a of the elevation mechanism 90 about the pillar 95, and detecting and calibrating the position of the upper portion 90a relative to the reference position of the pillar 95 and detecting the position of the lower portion 90b relative to the reference position of the pillar 95. Operation of only rotating the upper portion 90a about the pillar 95 would not cause any part of the product transfer apparatus 1 to contact the equipment, etc. around the product transfer apparatus 1. Therefore, in the operation of identifying that the arm unit 20 is placed in the area between the rails R, there is no risk that the arm unit 20 would damage the holder unit 10 or the surrounding equipment, etc.

Further, the retraction operation of the arm unit 20 into the area between the rails R is performed by moving the arm unit 20 in the direction perpendicular to the rails R. In this manner, it is possible to minimize the risk of contact between any part of the arm unit 20 or the holder unit 10 with shelf plates and the pillars of the shelves 410, 420 during this retraction operation. Further, by moving the product transfer apparatus 1 on the rails R with the arm unit 20 placed in the area between the rails R, it is possible to prevent contact of any part of the arm unit 20 or the holder unit 10 with the shelf plates and the pillars of the shelves 410, 420.

Further, if the arm unit 20 is positioned within the area between the two rails R, it is certain that the arm unit 20 and the holder unit 10 at the front end of the arm unit 20 are positioned remote from the surrounding equipment, etc. such as the shelves 410, 420. Therefore, even when the calibration operation is performed from this state, and the elevation mechanism 90 and/or the horizontal mechanism 80 of the product transfer apparatus 1 is moved, risk of contact of the arm unit 20 and the holder unit 10 with the surrounding equipment, etc. is small. Based on such estimation, after the operation control unit 152 determines that the arm unit 20 is positioned within the area between the two rails R or after the arm unit 20 is retracted into the area between the two rails R, it is possible to perform the calibration operation which involves movement of the elevation mechanism 90 in the vertical direction or movement of the horizontal movement mechanism 80 on the rails R.

While the present disclosure has been described through embodiments of the invention, the embodiments are not intended to limit the scope of the invention as claimed. Further, any form of combination of the features described in the embodiments of the present disclosure may also be included in the technical scope of the invention. Furthermore, it is also apparent to those skilled in the art that various modifications or improvements can be made to the embodiments described above.

1. A product transfer apparatus configured to move a product placed on a stock shelf to a product display shelf which is different from the stock shelf,
the product transfer apparatus comprising:
an arm unit having a holder unit configured to hold the product;
a movement mechanism configured to move in an area between the stock shelf and the product display shelf;
an acquisition unit configured to obtain a position of the arm unit; and
a control unit configured to control the arm unit, the holder unit, the movement mechanism, and the acquisition unit,
wherein the control unit is configured to perform:
acquiring a position of the arm unit relative to a reference position of the product transfer apparatus by the acquisition unit when operation of the product transfer apparatus is started from an operation stop state;
determining whether or not the arm unit is positioned within a predetermined area between the stock shelf and the product display shelf; and
moving the arm unit into the predetermined area if the arm unit is not positioned within the predetermined area.

2. The product transfer apparatus according to claim 1, wherein a track for movement of the movement mechanism is provided between the stock shelf and the product display shelf, the predetermined area is an area on the track; and
the moving the arm unit into the predetermined area includes moving the arm unit horizontally in a direction perpendicular to a longitudinal direction of the track.

3. The product transfer apparatus according to claim 1, further comprising:
a pillar having the reference position, and fixed to the movement mechanism; and
a main body provided with the arm unit, and supported by the pillar rotatably about the pillar,
the main body comprises:
a first main body part configured to rotate about the pillar; and
a second main body part configured to rotate about the pillar independently from the first main body part,
the acquisition unit comprises:
a first sensor provided for the first main body part, and configured to detect the reference position of the pillar;
a second sensor configured to detect a position in a rotation direction about the pillar, of the second main body part relative to the first main body part; and
a third sensor configured to obtain posture information of the arm unit, the obtaining the position of the arm unit relative to the reference position of the product transfer apparatus by the acquisition unit includes:
rotating the first main body part about the pillar up to a position where the first sensor detects the reference position, and calibrating the position of the first main body part relative to the reference position of the pillar;
rotating the first main body part about the pillar up to a position where the second sensor detects the position of the second main body part;
obtaining a rotation position of the second main body part relative to the reference position of the pillar in the rotation direction about the pillar, based on the reference position obtained by the first sensor and the position of the second main body part obtained by the second sensor; and
identifying a position of the arm unit relative to the reference position of the product transfer apparatus, based on the rotation position of the second main body part and the posture information of the arm unit obtained by the third sensor.

4. The product transfer apparatus according to claim 3, wherein the main body is configured to be movable in a vertical direction along the pillar, and the arm unit is configured to be movable in the vertical direction relative to the main body;
the product transfer apparatus comprises a fourth sensor configured to detect the height of the main body relative to the pillar, and a fifth sensor configured to detect the height of the arm unit relative to the main body; and
the control unit is configured to further perform:
moving the arm unit downward relative to the main body until the fifth sensor detects that the arm unit is positioned at a lower limit height of the main body, and calibrating the position of the arm unit relative to the lower limit height position; and
moving the main body downward relative to the pillar until the fourth sensor detects that the main body is positioned at the lower limit height of the pillar, and calibrating the position of the main body relative to the lower limit height position of the pillar.

5. The product transfer apparatus according to claim 4, wherein a track for movement of the movement mechanism is provided between the stock shelf and the product display shelf, and the predetermined area is an area on the track;
the product transfer apparatus includes a sixth sensor configured to detect a position of the product transfer apparatus on the track; and
the control unit is configured to further perform detecting the position of the product transfer apparatus on the track by the sixth sensor.

6. The product transfer apparatus according to claim 5, wherein the control unit is configured to further perform moving the arm unit to a safe position.

7. The product transfer apparatus according to claim 6, wherein the product transfer apparatus comprises a seventh sensor configured to detect an end position of the track in at least one of the longitudinal directions of the track; and
the control unit is configured to further perform moving the movement mechanism to the at least one of the longitudinal directions up to a position where the seventh sensor detects the end position, and calibrating a position of the product transfer apparatus relative to the end position of the track.

8. A method of controlling a product transfer apparatus configured to move a product placed on a stock shelf to a product display shelf which is different from the stock shelf,
the product transfer apparatus comprising:
an arm unit having a holder unit configured to hold the product;
a movement mechanism configured to move in an area between the stock shelf and the product display shelf;
an acquisition unit configured to obtain a position of the arm unit; and
a control unit configured to control the arm unit, the holder unit, the movement mechanism, and the acquisition unit,
wherein the method is performed by the control unit and including:
acquiring a position of the arm unit relative to a reference position of the product transfer apparatus by the acquisition unit when operation of the product transfer apparatus is started from an operation stop state;
determining whether or not the arm unit is positioned within a predetermined area between the stock shelf and the product display shelf; and
moving the arm unit into the predetermined area if the arm unit is not positioned within the predetermined area.

9. A non-transitory computer-readable storage medium storing a computer program thereon for controlling a product transfer apparatus configured to move a product placed on a stock shelf to a product display shelf which is different from the stock shelf, wherein the product transfer apparatus comprising: an arm unit having a holder unit configured to hold the product; a movement mechanism configured to move in an area between the stock shelf and the product display shelf; an acquisition unit configured to obtain a position of the arm unit; and a control unit configured to control the arm unit, the holder unit, the movement mechanism, and the acquisition unit; and
wherein the computer program when executed by one or more processor configures the control unit to perform:
acquiring a position of the arm unit relative to a reference position of the product transfer apparatus by the acquisition unit when operation of the product transfer apparatus is started from an operation stop state;
determining whether or not the arm unit is positioned within a predetermined area between the stock shelf and the product display shelf; and
moving the arm unit into the predetermined area if the arm unit is not positioned within the predetermined area.
